(19) United States
(12) Patent Application Publication
(10) Pub. No.: US 2026/0147397 A1
(43) Pub. Date: May 28, 2026

(54) DISTRIBUTED SYSTEM POWER MANAGEMENT

(71) Applicant: Dell Products L.P., Round Rock, TX (US)

(72) Inventors: SHIVENDRA KATIYAR, Bangalore (IN); NIKHIL S, Hyderabad (IN)

(21) Appl. No.: 18/962,762

(22) Filed: Nov. 27, 2024

(51) Int. Cl. G06F 1/3203

(52) U.S. Cl. CPC G06F 1/3203

(57) ABSTRACT

Methods, systems, and devices are provided for managing operation of data processing systems positioned in a rack. To do so a first identification of a change in a health state of a power supply of a power shelf positioned in the rack may be made, the power shelf supplying power to the data processing systems. Based on the first identification and the change in the health state, a second identification that existing power limits on power consumption by the data processing systems are stale may be made. Based on the second identification, new power limits may be obtained for the data processing systems based on the change in the health state. The new power limits on the data processing systems may be enforced to facilitate continued provisioning of computer implemented services by the data processing systems.

### FIELD

Embodiments disclosed herein relate generally to management of data processing systems. More particularly, embodiments disclosed herein relate to systems and methods for managing power consumed by data processing systems.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1A-1C show block diagrams illustrating systems in accordance with an embodiment.

FIG. 2 shows an interaction diagram illustrating processes and interactions for facilitating a power regulation framework in accordance with an embodiment.

FIG. 3 shows a flow diagram illustrating a method for managing operation of data processing systems positioned in a rack in accordance with an embodiment.

FIG. 4 shows a block diagram illustrating a data processing system in accordance with an embodiment.

### DETAILED DESCRIPTION

Various embodiments will be described with reference to details discussed below, and

the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing data processing systems in a distributed environment that may provide, at least in part, computer implemented services. The computer implemented services may be provided to any type and/or number of other devices and/or users of the data processing systems. Furthermore, the provided computer implemented services may be of any quantity and/or type of such services.

To provide the computer implemented services, data processing systems may include hardware components. For example, operation of these hardware components may facilitate various functionalities of a data processing system, thereby causing the data processing system to provide the computer implemented services.

To enable such operation of the hardware components, the hardware components may consume power required for such operation. This power may be provided by one or more power supply units, such as one or more power supply units positioned with a power shelf that provides power to any number of data processing systems positioned in any number of racks.

However, the one or more power supply units may be subjected to any number of unpredictable events, such as events that may impact future operation of a power supply unit of the power supply units.

For example, a malfunction of the power supply unit may reduce the power output capacity of the power shelf, thereby causing a shortage of power available for consumption by the hardware components, where the power required for the operation may be greater than the power available for consumption. Consequently, continued draw by the hardware components to consume the power required for the operation may negatively impact any of the hardware components, thereby delaying and/or preventing the computer implemented services from being provided.

To decrease a likelihood of these negative impacts, a power regulation framework may be leveraged. To do so, the power regulation framework may include (i) at least semi-consistently facilitating a health state polling of the power supply units in order to identify a health state change of any of the power supply units, and (ii) initiating, based on the identification, operations for managing power consumed by the hardware components.

In an embodiment, a method for managing operation of data processing systems positioned in a rack is provided.

The method may include making a first identification of a change in a health state of a power supply of a power shelf positioned in the rack, the power shelf supplying power to the data processing systems; based on the first identification: making, based on the change in the health state, a second identification that existing power limits on power consumption by the data processing systems are stale; based on the second identification: obtaining new power limits for the data processing systems based on the change in the health state; and enforcing the new power limits on the data processing systems to facilitate continued provisioning of computer implemented services by the data processing systems.

The power shelf may include a chassis adapted to be positioned in a slot of the rack, and the data processing systems may be positioned in other chassis that are adapted to be positioned in slots of the rack.

The power shelf may further include a plurality of power supplies that comprises the power supply, and a power manager adapted to monitor health states of the plurality of power supplies.

A second power shelf may be positioned in the rack, and the power shelf and the second power shelf may be adapted to cooperatively supply power to the data processing systems.

A shared power bus may be positioned with the rack, and the power shelf and the second power shelf may cooperatively power the shared power bus, and the data processing systems may draw power from the shared power bus.

The health state may indicate at least one selected from a list consisting of a current ability of the power supply to supply a nominal amount of power; and a future likelihood of the power supply to supply the nominal amount of the power in the future.

The new power limits may define allocated amounts of power that the data processing systems may be authorized to draw.

Enforcing the new power limits may include providing corresponding ones of the new power limits to management controllers of the data processing systems; and by a management controller of the management controllers, limiting power consumption by hardware components of a host data processing system of the data processing systems to be within one of the corresponding ones of the new power limits.

The new power limits may be based on a reduction in power supplying capacity indicated by the change in the health state.

The new power limits may be further based on desired levels of power consumption by the data processing systems, the new power limits proportionally dividing the reduced power supply capacity among the data processing systems based on the desired levels of power consumption.

In an embodiment, a non-transitory media is provided. The non-transitory media may include instructions that when executed by a processor cause, at least in part, the computer-implemented method to be performed.

In an embodiment, a data processing system is provided. The data processing system may include the non-transitory media and a processor and may, at least in part, perform the method when the computer instructions are executed by the processor.

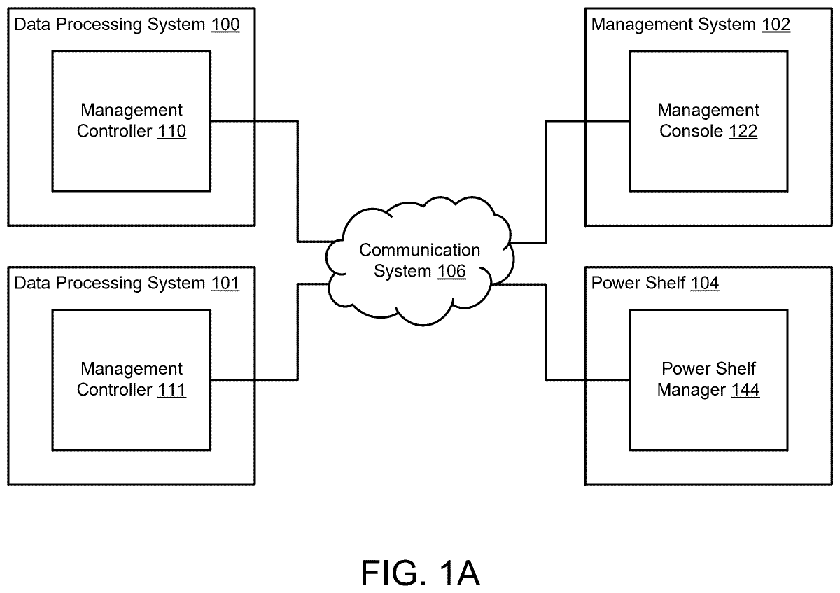

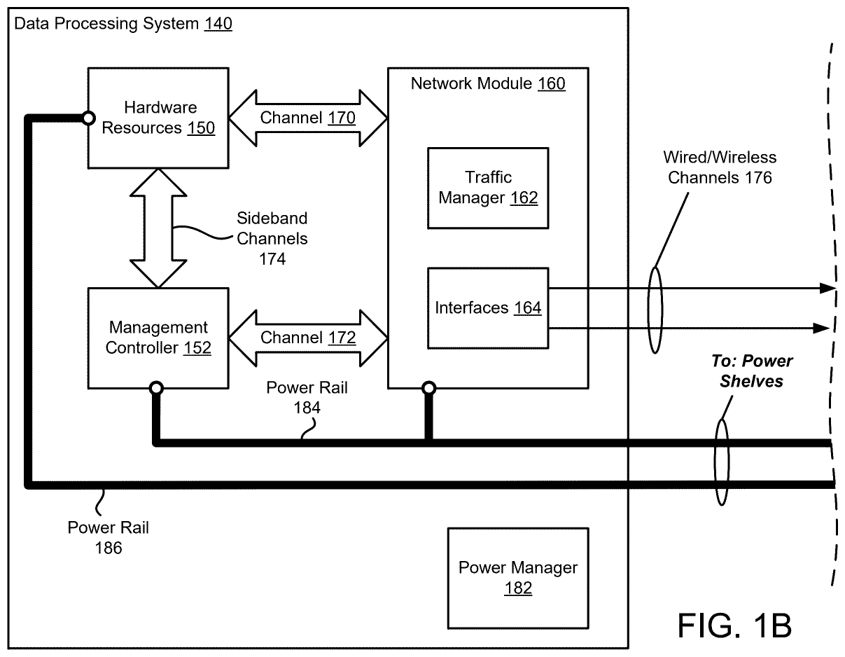

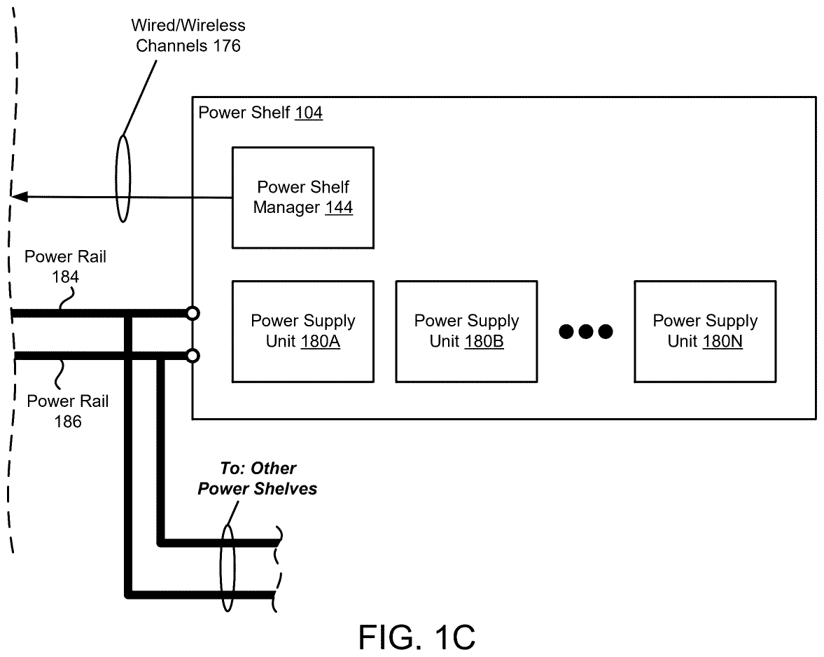

Turning to FIG. 1A, a block diagram illustrating a system in accordance with an embodiment is shown. The system shown in FIG. 1A may be a distributed system that provides computer implemented services.

These services may include any type and/or quantity of services. These services may include, for example, database services, data processing services, electronic communication services, and/or any other services that may be provided by one or more computing devices.

Other types of services may be provided by the system shown in FIG. 1A without departing from embodiments disclosed herein.

To provide these services, the system may include any number of data processing systems (e.g., computing devices), such as data processing systems 100 and 101, positioned in a rack. These data processing systems may include any quantity of hardware components. These components may include, for example, processors, memory modules, storage devices, communications devices, and/or any other type of component whose respective operation may facilitate various functionalities of the data processing systems. By facilitating such functionalities of the data processing systems, the respective operation of such components may cause the services to be provided.

To enable such operation of the hardware components, the hardware components may consume power required for such operation. This power may be provided by any number of power supply units, such as those that may be positioned with a power shelf to collectively provide power to the data processing systems positioned in the rack.

However, the power shelf may be subjected to any number of unpredictable events, such as events that may impact future operation of a single power supply unit of the power shelf. For example, such an event may include a malfunction of the power supply unit that may be caused by, for example, condensation dripping into the power shelf and onto the power supply unit.

For example, this malfunction of the power supply unit may reduce the collective power output capacity of the power shelf, thereby causing a shortage of power available for consumption by the hardware components, where the power required for the operation may be greater than the power available for consumption. Consequently, continued draw by the hardware components to consume the power required for the operation may negatively impact any of the hardware components, thereby delaying and/or preventing the computer implemented services from being provided.

To increase a likelihood of providing computer implemented services as expected and/or desired by a consumer of such services (e.g., an entity associated with the data processing systems in the rack), a distributed system may include components such as those illustrated and discussed with regard to FIG. 1A, below.

In general, embodiments disclosed herein relate to systems, devices, and methods for managing operation of data processing systems positioned in a rack that may provide computer implemented services. To do so, a power regulation framework may be leveraged.

This power regulation framework may include (i) facilitating a health state polling of the power supply units positioned with the power shelf (e.g., at least semi-consistently) in order to identify a health state change of any of the power supply units, and (ii) initiating, based on the identification, operations for managing power consumed by the hardware components.

For example, the increased likelihood of providing the services as expected may be due to performance of system management actions being based on identifying a risk of changes to an output power capacity of the power supply units (e.g., changes to a possible capability of the power supply units to provide a maximum power wattage that meets power requirements for the hardware components). For example, once performed, the identification of the risk may indicate that changes may occur to the output power capacity of the power supply units. Based on the identification, variable power draw capacities of the data processing systems may be managed.

To manage the variable power draw capacities, and based on the identification, a management console may be notified, thereby initiating a power cap calculation process to obtain new variable power draw capacities for the data processing systems.

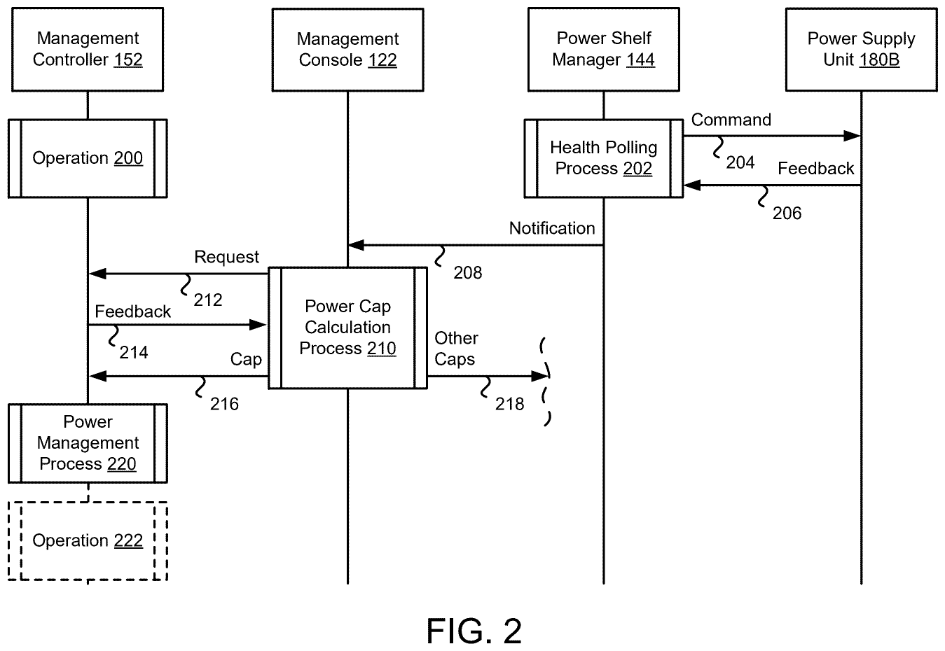

For additional information regard the power capacity calculation process, refer to FIG. 2.

Once one or more new capacities may be obtained for each data processing system, the capacities may be enforced by, for example, independent power management processes facilitated by respective data processing systems. Therefore, should the risk of the health state change be identified, and then actually occur, the enforced new variable power draw capacities may decrease the likelihood of these negative impacts delaying and/or preventing the services.

To provide the above noted functionality, the system of FIG. 1A may include data processing systems 100 and 101, management system 102, power shelf 104, and/or communication system 106. Each of these is discussed below.

It will be appreciated that even though illustrated to include just two data processing systems (e.g., 100 and 101), the system of FIG. 1A may include any number of data processing systems not to be limited by embodiments discussed herein. Any of these systems may (i) include hardware components that consume power to facilitate their own operation, (ii) depend on a power source, such as a power shelf (e.g., 104), to provide the power, (iii) include management controllers (e.g., 110 and 111, respectively), (iv) be managed, at least in part, by a management console (e.g., 122) hosted by, for example, a management system (e.g., 102) or a respective data processing system's hardware, (v) be stacked vertically with regard to one another in vertically aligned slots of a rack, and (vi) provide computer implemented services based on respective operation of the hardware components.

To provide their functionality, data processing systems 100 and 101 may be implemented by, for example, two computing devices such as servers positioned (e.g., stacked) vertically in a rack with regard to one another. For example, the rack may include a series of slots that are vertically positioned relative to one another (e.g., the vertically aligned slots), and each data processing system may include a chassis adapted to be inserted into one of the slots, the chassis housing respective hardware components of the data processing systems.

As mentioned above, these data processing systems (100 and 101) may include management controllers 110 and 111, respectively. The management controllers may facilitate the operation of the hardware components by (i) providing instructions/commands for the hardware components as well as (ii) facilitating communications with other devices such as the management system, other data processing systems, and/or a power shelf manager (e.g., 144). To provide their functionalities, these management controllers may be implemented with circuit card computer chips (e.g., such as processors).

Management system 102 may manage systems such as the any number of the data processing systems discussed with regard to the system of FIG. 1A. To do so, management system 102 may host management console 122. Management console 122 may (i) provide requests for information to the managed systems, (ii) provide information and/or commands to the managed systems, (iii) facilitate communications between the managed systems, (iv) obtain (via some means to be discussed further below) power requirements and constraints from the data processing systems, (v) obtain, based on the power requirements and constraints, new variable power draw capacities for the data processing systems, and (vi) initiating enforcement of the new variable power draw capacities for the data processing systems, and thereby enforcing, at least in part, the power regulation framework.

To provide its functionality, management console 122 may be implemented with, for example, a software application or a program, capable of being hosted, for example, by management system 102. It will be appreciated, however, that in some cases, management console 122 may be hosted by the data processing systems themselves, or any other device not to be limited by embodiments discussed herein.

Power shelf 104 may be the power source previously mentioned with regard to providing power that the hardware components are required to consume to enable their operation. Hence, power shelf 104 may provide power to the rack, the power capable of being provided being based on health states of the power supply units positioned with power shelf 104. It will be appreciated that although shown in FIG. 1A to have a single power shelf, the system of FIG. 1A may include any number of power shelves not to be limited by embodiments discussed herein.

To provide its functionality, power shelf 104 may be implemented by an enclosure (e.g., similar to the data processing systems'chassis) adapted to house and secure the power supply units within its interior, the enclosure also facilitating, at least in part, operable connections to, for example, a power bus adapted to, and positioned to, relay (e.g., provide) power to the data processing systems.

Power shelf 104 may (i) be adapted for placement into one of the vertically aligned slots of the rack, thereby being positioned at least somewhat proximate to each of the chassis of the data processing systems, (ii) include the any number of power supply units with any variance in a health state of each respective unit, (iii) include a power shelf manager (e.g., 144, discussed below) to manage information regarding the power supply units, and/or (iii) contribute to the total power being provided to the data processing systems. For example, if a rack includes two power shelves, these power shelves may both provide at least a portion (e.g., different portions from one another or a same quantity portion as one another) of power from respective power supplies to the total power available to the data processing systems. This power may be provided by power shelf 104 via a power bus positioned vertically along the height of the rack (e.g., oriented such that each chassis'position is proximate to the power bus. For example, the two power shelves may each provide half of the total power to the power bus, and each data processing system may draw power from a closest point along the power bus to enable respective operation of the hardware components.

As mentioned above, power shelf 104 may include power shelf manager 144. Power shelf manager 144 may (i) monitor health states of the power supply units housed within power shelf 104's enclosure (e.g., at least semi-consistently), (ii) identify whether there is a health state change in one of the monitored health states, and/or (iii) notify (e.g., alert) management console 122 of a health state change based on a positive identification (e.g., positive meaning an actual occurrence of change resulting in the identification) of at least one health state change of at least one power supply unit. In doing so, power shelf manager 122 may thereby initiate system management actions to modify a quantity of power being drawn (e.g., obtain and enforce new variable power draws) by the data processing systems.

In doing so, power shelf manager 144 may contribute to facilitating the power regulation framework along with management console 122 for the data processing systems (e.g., 100 and 101). It will be appreciated that the management controllers (e.g., 110 and 111) of the data processing systems may also contribute to the power regulation framework by providing information such as the previously mentioned power requirements and utilizations to management system 102 as well as receive instructions/commands to modify respective operations based on the positive identification of a health state change of at least one power supply unit.

For additional information regarding the power regulation framework, refer to FIGS. 1B-3.

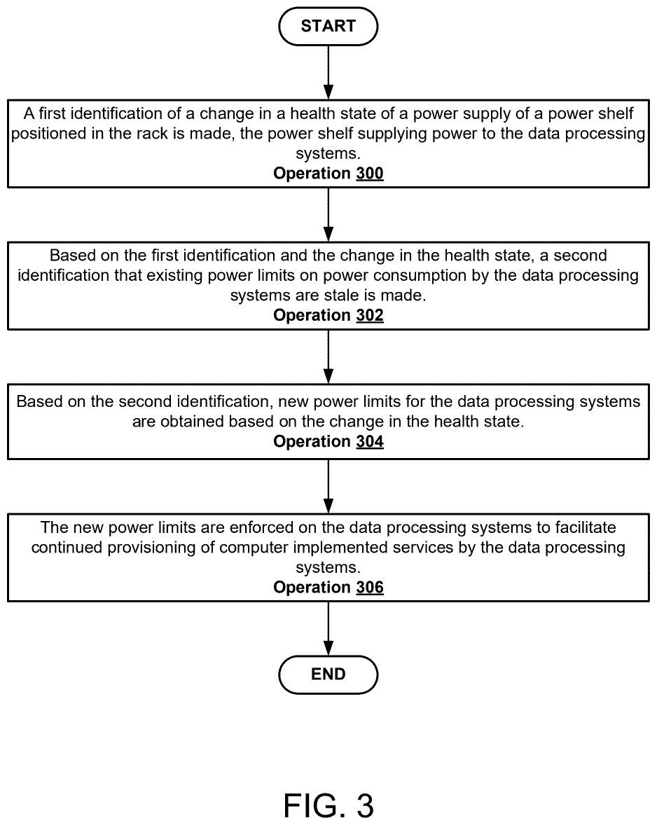

When providing their functionality, data processing systems 100 and 101, management system 102, and/or power shelf 104 may perform all, or a portion, of the method shown in FIG. 3.

Any devices (and/or components thereof) included in the system of FIG. 1A may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system.

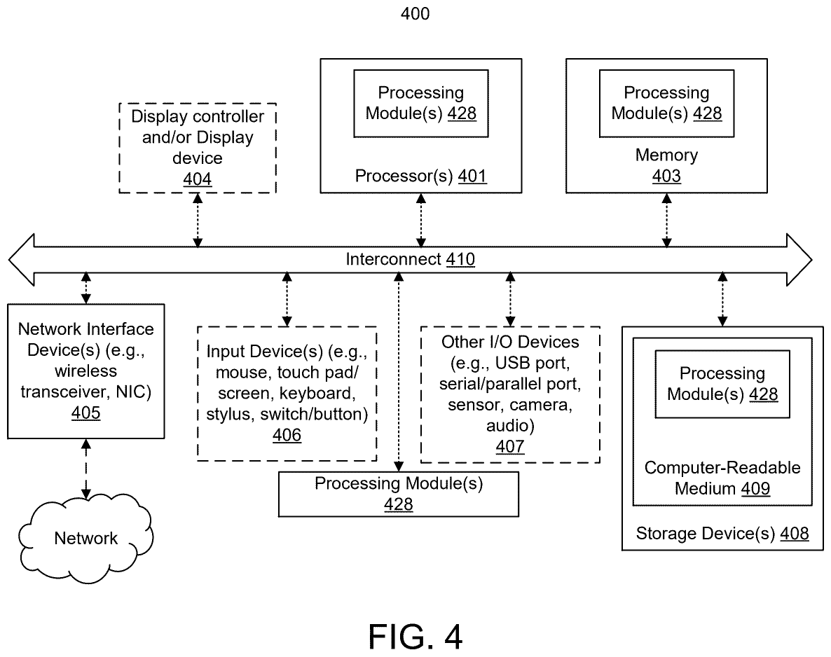

For additional details regarding computing devices, refer to FIG. 4.

Any of the components illustrated in FIG. 1A may be operably connected to each other (and/or components not illustrated) with a communication system (e.g., 106) utilized by data processing systems 100 and 101, management system 102, and/or power shelf 104 to, for example, cooperate with one another to facilitate the power regulation framework.

In an embodiment, this communication system may include one or more networks that facilitate communication between any number of components. The networks may include wired networks and/or wireless networks (e.g., and/or the Internet). The networks may operate in accordance with any number and types of communication protocols (e.g., such as the internet protocol).

Thus, by facilitating such a framework as the power regulation framework, there may be an increased likelihood of providing computer implemented services as expected and/or desired by the client by basing management of the system on the system's power related vulnerabilities throughout an environment.

While illustrated in FIG. 1A as including a limited number of specific components, a system in accordance with an embodiment may include fewer, additional, and/or different components than those illustrated therein.

To further clarify embodiments disclosed herein, additional block diagrams in accordance with an embodiment are shown in FIGS. 1B-1C.

Turning to FIG. 1B, a diagram illustrating data processing system 140 in accordance with an embodiment is shown. Data processing system 140 may be similar to any of the data processing systems shown in FIG. 1A (e.g., if not a same data processing system as 100 or 101). Therefore, it will be appreciated that although not explicitly shown in FIG. 1A, data processing system 140 may be included in the any number of data processing systems discussed with regard to FIG. 1A.

To provide computer implemented services, data processing system 140 may include any quantity of hardware resources 150. Hardware resources 150 may be in-band hardware components, and may include a processor operably coupled to memory, storage, and/or other hardware components.

The processor may host various management entities such as operating systems, drivers, network stacks, and/or other software entities that provide various management functionalities. For example, in cases where the system of FIG. 1A does not include management system 102, management console 122 may, at least in part, also be hosted by the processor along with the operating system and drivers for data processing system 140. By hosting such software entities, the processor may facilitate abstracted access to various hardware resources.

Likewise, the network stack may facilitate packaging, transmission, routing, and/or other functions with respect to exchanging data with other devices. For example, the network stack may support transmission control protocol/internet protocol communication (TCP/IP) (e.g., the Internet protocol suite) thereby allowing the hardware resources 150 to communicate with other devices via packet switched networks and/or other types of communication networks.

The processor may also host various applications that provide the computer implemented services. The applications may utilize various services provided by the management entities and use (at least indirectly) the network stack to communication with other entities.

For example, to communicate with other entities, an application may generate and send communications to a network stack and/or driver, which may subsequently transmit a packaged form of the communication via channel 170 to a communication component, which may then send the packaged communication (in a yet further packaged form, in some embodiments, with various layers of encapsulation being added depending on the network environment outside of data processing system 140) to another device via any number of intermediate networks (e.g., via wired/wireless channels 176 that are part of the networks).

To manage the applications and/or other in-band entities, data processing system 140 may further include management controller 152 and network module 160. Each of these components of data processing system 140 is discussed below.

Management controller 152 may be implemented, for example, using a system on a chip or other type of independently operating computing device (e.g., independent from the in-band components, such as hardware resources 150) of a host data processing system (e.g., 140). Management controller 152 may provide various management functionalities for data processing system 140. For example, management controller 152 may monitor various ongoing processes performed by the in-band component, may manage power distribution, thermal management, and/or other functions of data processing system 140.

To do so, management controller 152 may be operably connected to various components via sideband channels 174 (in FIG. 1B, a limited number of sideband channels are included for illustrative purposes, it will be appreciated that management controller 152 may communication with other components via any number of sideband channels). The sideband channels may be implemented using separate physical channels, and/or with a logical channel overlay over existing physical channels (e.g., logical division of in-band channels). The sideband channels may allow management controller 152 to interface with other components and implement various management functionalities such as, for example, general data retrieval (e.g., to snoop ongoing processes), telemetry data retrieval (e.g., to identify a health condition/other state of another component), function activation (e.g., sending instructions that cause the receiving component to perform various actions such as displaying data, adding data to memory, causing various processes to be performed), and/or other types of management functionalities.

For example, during the power regulation framework, management controller 152 may obtain instructions/commands to modify operation of the other components to modify a quantity of power drawn by the other components. The operation may be modified, for example, by using sideband channels 174 to instruct the other components to throttle their respective operations, thereby drawing less power. For additional information regarding the instructions/commands, refer to FIG. 2.

Management controller 152 may be operably connected to communication components of data processing system 140 via separate channels (e.g., 172) from the in-band components, and may implement or otherwise utilize a distinct and independent network stack (e.g., TCP/IP). Consequently, management controller 152 may communication with other devices independently of any of the in-band components (e.g., does not rely on any hosted software, hardware components, etc.).

To facilitate communication with other devices, data processing system 140 may include network module 160. Network module 160 may provide communication services for in-band components and out-of-band components (e.g., management controller 152) of data processing system. To do so, network module 160 may include traffic manager 162 and interfaces 164.

Traffic manager 162 may include functionality to (i) discriminate traffic directed to various network endpoints advertised by data processing system 140, and (ii) forward the traffic to/from the entities associated with the different network endpoints. For example, to facilitate communications with other devices, network module 160 may advertise different network endpoints (e.g., different media access control address/internet protocol addresses) for the in-band components and out-of-band components. Thus, other entities may address communications to these different network endpoints. When such communications are received by network module 160, traffic manager 162 may discriminate and direct the communications accordingly (e.g., over channel 170 or channel 172, in the example shown in FIG. 1B, it will be appreciated that network module 160 may discriminate traffic directed to any number of data units and direct it accordingly over any number of channels).

Accordingly, traffic directed to management controller 152 may never flow through any of the in-band components. Likewise, outbound traffic from the out-of-band component may never flow through the in-band components.

To support inbound and outbound traffic, network module 160 may include any number of interfaces 164. Interfaces 164 may be implemented using any number and type of communication devices which may each provide wired and/or wireless communication functionality. For example, interfaces 164 may include a wide area network card, a WiFi card, a wireless local area network card, a wired local area network card, an optical communication card, and/or other types of communication components. These components may support any number of wired/wireless channels 176. For example, one such channel may facilitate communication with a power shelf manager (e.g., 144) to facilitate the power regulation framework as discussed below and with regard to FIG. 1C.

Thus, from the perspective of an external device, the in-band components and out-of-band components of data processing system 140 may appear to be two independent network entities, which may be independently addressable, and otherwise unrelated to one another.

To facilitate management of data processing system 140 over time, hardware resources 150, management controller 152 and/or network module 160 may be positioned in separately controllable power domains. By being positioned in these separately powered domains, different subsets of these components may remain powered while other subsets are unpowered.

For example, management controller 152 and network module 160 may remain powered while hardware resources 150 is unpowered. Consequently, management controller 152 may remain able to communication with other devices even while hardware resources 150 are inactive. Similarly, management controller 152 may perform various actions while hardware resources 150 are not powered and/or are otherwise inoperable, unable to cooperatively perform various process, are compromised, and/or are unavailable for other reasons.

To implement the separate power domains, data processing system 140 may include a power source (e.g., power shelf 104 as discussed with regard to FIG. 1A) that separately supplies power to power rails (e.g., 184, 186) that power the respective power domains. Power from the power source (e.g., power shelf, power supply, battery, etc.) may be selectively provided to the separate power rails to selectively power the different power domains. A power manager (e.g., 182) may manage power from power shelf 104 that is supplied to the power rails. Management controller 152 may cooperate with power manager 182 to manage supply of power to these power domains.

Turning to FIG. 1C, a diagram illustrating power shelf 104 (e.g., as discussed with regard to FIGS. 1A-1B) in accordance with an embodiment is shown.

To enable data processing system 140 to provide computer implemented services, power shelf 104 may include any quantity of power supply units (e.g., 180A-180N) that are positioned with one another inside power shelf 104 such that they may collectively provide power to be consumed by, for example, the components of data processing system 140 in addition to any other data processing systems positioned in the rack (e.g., 100 and 101). For example, these power supply units may provide the power drawn by data processing system 140 via power rails 184 and 186 operably connecting power shelf 104 to data processing system 140.

Power shelf 104 may further include a processor such as power shelf manager 144 (previously mentioned) operably coupled to memory, storage, and/or other hardware components such as the power supply units. In doing so, power shelf manager 144 may be adapted to monitor health states of the power supply units positioned in power shelf 104 to increase a likelihood of identifying a change in a health state of any one of the power supply units, should the change occur.

For example, such a change may be indicative of a future degradation of the any one of the power supply units. Consequently, a power output capacity of power shelf 104 nay be reduced in the future due to the degradation. Therefore, should a change in the health state be identified, such identification may be used to modify operation of data processing system 140 such that data processing system 140 draws less power from power shelf 104.

To modify the operation, power shelf manager 144 may, based on the identification, notify management console 122 hosted by management controller 152 via wired/wireless channels 176 of the change in the health state (e.g., assuming that the system of FIG. 1A does not include management system 102). In cases where the system of FIG. 1A includes management system 102, wired/wireless channels 176 would facilitate communications from power shelf manager 144 to management console 122 hosted by management system 102.

In FIGS. 1B-1C, an example implementation of separate power domains using power rails 184-186 is shown. The power rails may be implemented using, for example, bus bars or other types of transmission elements capable of distributing electrical power. While not shown, it will be appreciated that the power domains may include various power management components (e.g., fuses, switches, etc.) to facilitate selective distribution of power within the power domains.

It will be appreciated that in some cases, these power rails may further operably connect additional power shelves and/or additional data processing systems, as shown in FIG. 1B-1C.

While illustrated in FIGS. 1A-1C as including a limited number of specific components, a system in accordance with an embodiment may include fewer, additional, and/or different components than those illustrated therein.

To further clarify embodiments disclosed herein, an interaction diagram in accordance with an embodiment is shown in FIG. 2. This interaction diagram may illustrate how data may be obtained and used within the system of FIG. 1A.

In the interaction diagrams, processes performed by and interactions between components of a system in accordance with an embodiment are shown. In the diagrams, components of the system are illustrated using a first set of shapes (e.g., 152, 122, etc.), located towards the top of each figure. Lines descend from these shapes. Processes performed by the components of the system are illustrated using a second set of shapes (e.g., 200, 202, etc.) superimposed over these lines. Interactions (e.g., communication, data transmissions, etc.) between the components of the system are illustrated using a third set of shapes (e.g., 204, 208, 218, etc.) that extend between the lines. The third set of shapes may include lines terminating in one or two arrows. Lines terminating in a single arrow may indicate that one-way interactions (e.g., data transmission from a first component to a second component) occur, while lines terminating in two arrows may indicate that multi-way interactions (e.g., data transmission between two components) occur.

Generally, the processes and interactions are temporally ordered in an example order, with time increasing from the top to the bottom of each page. For example, the interaction labeled as 204 may occur prior to the interaction labeled as 206. However, it will be appreciated that the processes and interactions may be performed in different orders, any may be omitted, and other processes or interactions may be performed without departing from embodiments disclosed herein.

The lines descending from some of the first set of shapes (e.g., 222, etc.) is drawn in dashing to indicate, for example, that the corresponding components may not be (i) operable, (ii) powered on, (iii) present in the system, and/or (iv) not participating in operation of the system for other reasons. For example, operation 222 may be a different operation to that of operation 200.

Turning to FIG. 2, an interaction diagram in accordance with an embodiment is shown. The interaction diagram may illustrate processes and interactions that may occur during facilitation of the power regulation framework.

For example, assume that a rack includes two or more slots, power shelf 104 being positioned in a first slot of the slots and data processing system 140 being positioned in a second slot of the slots. It will be appreciated that any number of additional slots of the rack may include, respectively, any number of other data processing systems and/or any number of other power shelves.

Further assume that each power supply unit positioned in power shelf 104 is initially operating at full health (e.g., an optimal and/or default health state of each power supply unit). While at this full health, a quantity of power may be drawn by data processing system 140 as part of enabling operation 200 (e.g., an initial operation of data processing system 140).

To facilitate the power regulation framework, power shelf manager 144 may perform health polling process 202 to check for changes in health states of each of the power supply units positioned in power shelf 104. To do so, power shelf manager 144 may, for each of the power supply units, (i) provide a request or command that initiates feedback from a respective power supply unit, (ii) obtaining the feedback based on the request or command, the feedback indicating a current health state of the respective power supply unit, and (iii) determining if the respective power supply unit's health state has changed (e.g., assuming at least one prior iteration of health polling process 202 has been performed and/or that power shelf manager 144 may otherwise know a prior health state of the respective power supply unit).

For example, during health polling process 202, at interaction 204, power shelf manager 144 may provide a command that causes power supply unit 180B (a power supply unit in power shelf 104 and discussed with regard to FIG. 1C) to reactively provide, at interaction 206, feedback to power shelf manager 144.

This command may be implemented, for example, by portions of power drawn from power supply unit 180B by power shelf manager 144 in a manner that tests electrical outputs of power supply unit 180B to identify various characteristics of power supply unit 180B, such as its integrity, its efficiency, and/or its range for providing power.

Once power is drawn, power shelf manager 144 may obtain measurements associated with, and identify associated characteristics of, power supply unit 180B based on the power drawn. Based on these measurements and associated characteristics, power shelf manager 144 may perform a check as to determine whether the power drawn is as expected (e.g., consistent with previous monitoring of power supply unit 180B), or if it may be indicative of a change in the health state of power supply unit 180B.

It will be appreciated that such previous monitoring may be implemented, for example, by (i) at least one prior iteration of health polling process 202 having been performed and/or (ii) a known prior health state (and/or default health state) of the respective power supply unit that may be otherwise known to power shelf manager 144.

Assume that, in this example discussed with regard to FIG. 2, that the health state of power supply 180B is determined by power shelf manager 144 to have changed. For example, assume that one of the cables facilitating operable connection between power supply unit 180B and power shelf manager 144 was able to provide the power drawn only intermittently, and that power shelf manager 144 was able to identify this intermittent power.

Based on this health state change, power shelf manager 144 may, at interaction 208, provide a notification to management console 122 to notify management console 122 of the change. Based on receiving this notification, management console 122 may perform power cap calculation process 210.

During power cap calculation process 210, management console 122 may (i) identify, for the a new maximum capacity of power output possible based on the health state change, (ii) obtain information regarding operation 200, power consumed to facilitate operation 200, priority rankings for data processing systems (and/or components therein) positioned with the rack, (iii) make a determination based on the obtained information regarding whether the existing power limits on power consumption by the data processing systems are stale, and, based on the determination, (iv) obtain new power limits for the data processing systems (and/or components therein) based on the change in the health state.

For example, the intermittent power output provided by power supply unit 180B may be deemed unreliable by management console 122, and therefore, may not be included in calculations that determine a total power available for consumption by devices positioned in the rack. Thus, the new maximum power output capacity of the power shelf may be obtained based on the health state change (e.g., in this case, the new output capacity being lower than the previous output capacity.

To obtain the information, management console 122 may request various portions of the information from devices positioned with the rack. For example, at interaction 212, management console 122 may provide a request to management controller 152 (of data processing system 140) for associated portions of the information to be made accessible and/or provided to management console 122. These associated portions may include processes queued for performance, what components facilitate that performance, and/or how much power consumption is required by the components to enable that facilitation.

For example, at interaction 214, management controller 152 may provide feedback to management console 122. This feedback may include any combination of the associated portions (associated with data processing system 140 in this example context).

Additionally, processes may include associated priority rankings that identify an importance associated with how necessary/imperative performance of particular processes may be. Furthermore, these priority rankings may extend to ranking whole data processing systems to differentiate between data processing system in the rack, enabling some devices and their respective processes to be prioritized over other.

To make the determination regarding whether the existing power limits on power consumption by the data processing systems are stale, a current power consumption by the rack to facilitate operation 200 may be compared to the total power available for consumption (after discovery of the health state change) by devices positioned in the rack. If the current power consumption exceeds (and/or meets, since power fluctuations are possible as based on unexpected events that may impact the rack) the total power available for consumption, then the existing power limits on power consumption by the data processing systems may be determined to be stale.

If stale, management console 122 may obtain new power limits for the data processing systems (and/or components therein) based on the change in the health state. These new power limits may be for data processing systems and/or specific and respective components of the data processing systems, and may be based, at least in part, on the obtained information to obtain a plan for facilitating a new operation (e.g., operation 222) that most effectively adheres to, for example, the priority ranking, minimum required power consumptions, and/or any other restraints placed on and/or associated with operation of the data processing systems in the rack (e.g., operation 200) to continue to provide computer implemented services.

For additional information regarding the power cap calculation process (e.g., 210), refer to FIG. 3 discussed further below.

Once the new power limits are obtained, the new power limits may be provided to respective management controllers of corresponding data processing systems. For example, at interaction 216, a cap may be provided to management controller 152. This cap may include limits on power consumption by data processing system 140 as a whole, and/or limits on power consumption by specific/individual components of data processing system 140.

Similarly, for example, at interaction 218, other caps may be provided to the other data processing systems, respectively.

By providing the new power limits, management console 122 may initiate enforcement of the new power limits on the data processing systems to facilitate as close to continued provisioning of the computer implemented services as they were by the data processing systems during operation 200.

For example, once the cap is provided, management controller 152 may perform power management process 220 based on the cap. During power management process 220, management controller 152 may modify processes and/or the queue of processes to meet the new power limits indicated by the cap. For example, such modification may include throttling power to one or more components of data processing system 140. Similarly, for example, such throttling and/or other such modifications may be performed by other management controllers of the other data processing systems based on at least a portion of the other caps provided via interaction 218.

Based on performance of power management process 220, operation of management controller 152, operation of the rest of data processing system 140, and/or operation of the rack as a whole, may be changed. Thus, performance of operation 222 may be initiated and facilitated until these newly existing power limits on power consumption by the data processing systems are determined to be stale.

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor-based devices (e.g., computer chips).

Any of the data structures illustrated using the first and third set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

For additional information and/or examples regarding the power regulation framework, refer to FIG. 3 further below.

Thus, as discussed with regard to FIGS. 1A-2, a power regulation framework may be facilitated by any number of devices such as data processing systems 100 and 101, management console 122, and/or power shelf manager 144 cooperating with one another as part of, for example, the distributed system shown and discussed with regard to FIG. 1A.

While illustrated in FIG. 2 with a limited number of specific components, a system may include additional, fewer, and/or different components without departing from embodiments disclosed herein.

As discussed above, the components of FIGS. 1A-2 may facilitate and/or perform various functionalities to facilitate the power regulation framework. FIG. 3 illustrates a method that may be facilitated and/or performed by the components of FIGS. 1A-2.

In the diagram discussed below and shown in FIG. 3, any of the operations may be repeated, performed in different orders, and/or performed in parallel with or in a partially overlapping in time manner with other operations.

Turning to FIG. 3, a flow diagram illustrating a method for managing operation of data processing systems positioned in a rack in accordance with an embodiment is shown. The method may be performed, for example, by a management console (e.g., 122), a power shelf manager (e.g., 144), and/or any other entity.

At operation 300, a first identification of a change in a health state of a power supply of a power shelf positioned in the rack is made, the power shelf supplying power to the data processing systems. The first identification may be made by monitoring health states of a plurality of power supplies in the power shelf, the power supply being one of the plurality of power supplies.

For example, assume the power shelf includes a chassis adapted to be positioned in a slot of the rack, this chassis at least partially housing the plurality of power supplies. This plurality of power supplies housed by the power shelf's chassis may collectively provide the power that is supplied to the data processing systems by the power shelf, the data processing systems being positioned in other chassis adapted to be positioned in slots of the rack.

In some cases, the rack may have more than one power shelf. In such cases, it will be appreciated that if a second power shelf is positioned in the rack, the power shelf and the second power shelf may be adapted to cooperatively supply power to the data processing systems, each power shelf respectively supplying a quantity of power provided by (e.g. based on) respectively housed power supplies. For example, a shared power bus may be positioned with the rack, and the power shelf and the second power shelf may cooperatively power the shared power bus, and the data processing systems may draw power from the shared power bus.

To make the first identification, the power shelf (and each power shelf positioned in the rack) may further include a power shelf manager that may also be housed by the power shelf's chassis along with the plurality of power supplies. This power shelf manager may be adapted to monitor the health states of the plurality of power supplies.

To monitor the health states of the plurality of power supplies, the power shelf manager may, for each power supply of the plurality of power supplies, (i) checking a current health state of a power supply, and (ii) checking whether the current health state is different from a prior health state of the power supply.

To check the current health state, the power shelf manager may initiate testing of the power supply that causes the power shelf manager to draw various quantities (e.g., portions) of power from the power supply in any number of ways, magnitudes, and/or that may vary by any degree of complexity (e.g., intermittent power draw wherein each draw (i) causes 1.5watts of power to be consumed and (ii) is separated by two seconds). The power that is actually consumed during this testing may indicate, for example, (i) a current ability of the power supply to supply a nominal amount of power, and (ii) a future likelihood of the power supply to supply the nominal amount of the power in the future. The actual power consumed and/or what is indicated by the actual power consumed may be compared to power consumed during the checking of the prior health state and/or what was indicated by the power consumed during the checking of the prior health state.

Based on this comparison, the first identification may be made if the current health state is different from the prior health state, the first identification resulting in the power shelf manager notifying a management console of the health state change.

For additional information regarding the management console and/or the monitoring of the health states, refer to FIGS. 1A-2, previously discussed.

At operation 302, a second identification is made, based on the first identification and the change in the health state, that existing power limits on power consumption by the data processing systems are stale. The second identification may be made by, for example, (i) obtaining the existing power limits that define current levels of power consumption by the data processing systems, (ii) obtaining a maximum power output capacity of the one or more power shelves that specifies total available power capable of being drawn by the data processing systems, (iii) comparing the maximum power output capacity and the existing power limits, and (iv) based on the comparison, making a determination regarding whether the existing power limits exceed the maximum power output capacity.

If the existing power limits exceed the maximum power output capacity, the data processing systems may attempt to draw more power than is available for consumption, resulting in an increased likelihood of negatively impacting the hardware components, and therefore, having an increased likelihood of delaying and/or preventing the computer implemented services from being provided. Thus, should the existing power limits exceed the maximum power output capacity, the second identification may be made that the existing power limits on power consumption by the data processing system are stale.

At operation 304, new power limits for the data processing systems are obtained based on the second identification and based on the change in the health state. The new power limits may be obtained by (i) identifying priority rankings of the data processing systems that indicate, for each of the data processing systems (e.g., as well as respectively queued operations), associated importance of continuing the respectively queued operations, (ii) obtaining, based on the priority rankings, the respectively queued operations, and the maximum power output capacity, power requirements of the data processing systems, and (iii) identifying allocated amounts of power that the data processing systems are authorized to draw that do not exceed the maximum power output capacity. Therefore, new allocated amounts of power that the data processing systems are authorized to draw may be identified by performing a power cap calculation process as discussed with regard to FIG. 2. By identifying these new allocated amounts of power, the new power limits may be obtained, the new power limits defining the new allocated amounts of power.

Thus, the new power limits may be based on (i) a reduction in power supplying capacity indicated by the change in the health state as well as (ii) desired levels of power consumption by the data processing systems, the new power limits proportionally dividing the reduced power supply capacity among the data processing systems based on the desired levels of power consumption.

At operation 306, the new power limits are enforced on the data processing systems to facilitate continued provisioning of computer implemented services by the data processing systems. The new power limits may be enforced by (i) providing corresponding ones of the new power limits to management controllers of the data processing systems, and (ii) a respective management controller of the management controllers limiting power consumption by corresponding hardware components of a host data processing system of the data processing systems to be within a respective one of the corresponding ones of the new power limits. For example, the respective management controller may limit power consumption via throttling of the corresponding hardware components to enforce (at least in part) the respective one of the corresponding ones of the new power limits.

The method may end following operation 306.

Thus, using the method illustrated in FIG. 3, embodiments disclosed herein may manage systems to increase the likelihood of providing the computer implemented services as expected and/or desired by the client.

Any of the processes and/or components illustrated in and/or discussed with regard to FIGS. 1A-3 may be implemented with and/or used in conjunction with one or more computing devices.

Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high-level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random-access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a Wi-Fi transceiver, an infrared transceiver, a Bluetooth transceiver, a WiMAX transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid-state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also, a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components as such details are not germane to embodiments disclosed herein. It will also be appreciated that network computers, handheld computers, mobile phones, servers, and/or other data processing systems which have fewer components, or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g., circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing operation of data processing systems positioned in a rack, the method comprising:
making a first identification of a change in a health state of a power supply of a power shelf positioned in the rack, the power shelf supplying power to the data processing systems;
based on the first identification:
making, based on the change in the health state, a second identification that existing power limits on power consumption by the data processing systems are stale;
based on the second identification:
obtaining new power limits for the data processing systems based on the change in the health state; and
enforcing the new power limits on the data processing systems to facilitate continued provisioning of computer implemented services by the data processing systems.

2. The method of claim 1, wherein the power shelf comprises a chassis adapted to be positioned in a slot of the rack, and the data processing systems are positioned in other chassis that are adapted to be positioned in slots of the rack.

3. The method of claim 2, wherein the power shelf further comprises:
a plurality of power supplies that comprises the power supply, and a power manager adapted to monitor health states of the plurality of power supplies.

4. The method of claim 3, wherein a second power shelf is positioned in the rack, and the power shelf and the second power shelf are adapted to cooperatively supply power to the data processing systems.

5. The method of claim 4, wherein a shared power bus is positioned with the rack, and the power shelf and the second power shelf cooperatively power the shared power bus, and the data processing systems draw power from the shared power bus.

6. The method of claim 1, wherein the health state indicates at least one selected from a list consisting of:
a current ability of the power supply to supply a nominal amount of power; and
a future likelihood of the power supply to supply the nominal amount of the power in the future.

7. The method of claim 1, wherein the new power limits define allocated amounts of power that the data processing systems are authorized to draw.

8. The method of claim 7, wherein enforcing the new power limits comprises:
providing corresponding ones of the new power limits to management controllers of the data processing systems; and
by a management controller of the management controllers:
limiting power consumption by hardware components of a host data processing system of the data processing systems to be within one of the corresponding ones of the new power limits.

9. The method of claim 7, wherein the new power limits are based on a reduction in power supplying capacity indicated by the change in the health state.

10. The method of claim 9, wherein the new power limits are further based on desired levels of power consumption by the data processing systems, the new power limits proportionally dividing the reduced power supply capacity among the data processing systems based on the desired levels of power consumption.

11. A non-transitory machine-readable medium having instructions stored therein, which when executed by a processor, cause the processor to perform operations for managing operation of data processing systems positioned in a rack, the operations comprising:
making a first identification of a change in a health state of a power supply of a power shelf positioned in the rack, the power shelf supplying power to the data processing systems;
based on the first identification:
making, based on the change in the health state, a second identification that existing power limits on power consumption by the data processing systems are stale;
based on the second identification:
obtaining new power limits for the data processing systems based on the change in the health state; and
enforcing the new power limits on the data processing systems to facilitate continued provisioning of computer implemented services by the data processing systems.

12. The non-transitory machine-readable medium of claim 11, wherein the power shelf comprises a chassis adapted to be positioned in a slot of the rack, and the data processing systems are positioned in other chassis that are adapted to be positioned in slots of the rack.

13. The non-transitory machine-readable medium of claim 12, wherein the power shelf further comprises:
a plurality of power supplies that comprises the power supply, and
a power manager adapted to monitor health states of the plurality of power supplies.

14. The non-transitory machine-readable medium of claim 13, wherein a second power shelf is positioned in the rack, and the power shelf and the second power shelf are adapted to cooperatively supply power to the data processing systems.

15. The non-transitory machine-readable medium of claim 14, wherein a shared power bus is positioned with the rack, and the power shelf and the second power shelf cooperatively power the shared power bus, and the data processing systems draw power from the shared power bus.

16. A data processing system, comprising:
a processor; and
a memory coupled to the processor to store instructions, which when executed by the processor, cause the processor to perform operations for managing operation of
data processing systems positioned in a rack, the operations comprising:
making a first identification of a change in a health state of a power supply of a power shelf positioned in the rack, the power shelf supplying power to the data processing systems;
based on the first identification:
making, based on the change in the health state, a second identification that existing power limits on power consumption by the data processing systems are stale;
based on the second identification:
obtaining new power limits for the data processing systems based on the change in the health state; and
enforcing the new power limits on the data processing systems to facilitate continued provisioning of computer implemented services by the data processing systems.

17. The data processing system of claim 16, wherein the power shelf comprises a chassis adapted to be positioned in a slot of the rack, and the data processing systems are positioned in other chassis that are adapted to be positioned in slots of the rack.

18. The data processing system of claim 17, wherein the power shelf further comprises:
a plurality of power supplies that comprises the power supply, and
a power manager adapted to monitor health states of the plurality of power supplies.

19. The data processing system of claim 18, wherein a second power shelf is positioned in the rack, and the power shelf and the second power shelf are adapted to cooperatively supply power to the data processing systems.

20. The data processing system of claim 19, wherein a shared power bus is positioned with the rack, and the power shelf and the second power shelf cooperatively power the shared power bus, and the data processing systems draw power from the shared power bus.
